(19) United States
(12) Patent Application Publication
(10) Pub. No.: US 2005/0008907 A1
(43) Pub. Date: Jan. 13, 2005

(54) Fuel cell system

(75) Inventors: Yoshiyuki Isozaki, Edogawa-ku (JP); Yuusuke Sato, Bunkyo-ku (JP); Nobutaka Kikuiri, Koganei-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 10/842,430

(22) Filed: May 11, 2004

(30) Foreign Application Priority Data
May 14, 2003 (JP) 2003-136173

(51) Int. Cl. H01M 8/06

(52) U.S. Cl. 429/20; 429/34

(57) ABSTRACT

A fuel cell system includes a fuel section storing fuel; a vaporizer vaporizing the fuel; a reformer reforming the fuel into reformed gas containing hydrogen; a CO remover configured to reduce or remove carbon monoxide from reformed gas; a fuel cell body having an anode configured to introduce the reformed gas from the CO remover and emit exhaust gas containing hydrogen and a cathode configured to introduce oxygen to react with hydrogen; and a circulation path configured to circulate exhaust gas configured to circulate the exhaust gas to the reformer.

### CROSS REFERENCE TO RELATED APPLICATIONS

This application is based upon and claims the benefit of priority from the prior Japanese Patent Applications No. P2003-136173, filed on May 14, 2003; the entire contents of which are incorporated herein by reference

### BACKGROUND OF THE INVENTION

1. Field of the Invention

The present invention relates to a fuel cell system, more specifically to a fuel cell system suitable in miniaturization.

2. Description of the Related Art

Equipment such as office automation (OA) equipment, audio equipment, and radio equipment has been miniaturized and along with the progress in semiconductor technology, and portability is required for the equipment to function. A primary battery or a secondary battery has been used as the battery for satisfying the requirement.

When the primary battery is used for OA equipment, OA equipment can continue to operate by exchanging the battery. However, the available time of the primary battery is generally short. Therefore, the primary battery is not suitable for portable equipment.

When the secondary battery is used, the same battery can be used again by recharging. Therefore, the secondary battery is suitable for use in portable equipment. However, the secondary battery requires a power supply for recharging and moreover requires time to be charged. OA equipment or the like which incorporates the secondary battery inside are especially limited in terms of the place so as to ensure that there is a power supply for recharging since the battery is difficult to exchange. Moreover, the available time of the equipment is also limited. As described above, the conventional primary and secondary batteries are inadequate for operating small equipment for a long time, so there has been a demand for the development of a battery which is suitable for use for a longer time.

Recently, a fuel cell has focused on sources of energy for portable communications and computing products. The fuel cell can continue to generate electricity for a long time by exchanging fuel. A miniaturized fuel cell and a so-called micro-fuel cell can be advantageous systems for operating small equipment such as OA equipment with a small power consumption.

In a general fuel cell field, a fuel cell system has been developed which generates electricity by allowing reformed gas which contains hydrogen into an anode and allows air into a cathode, to generate electricity. The reformed gas containing hydrogen is obtained by reforming fuels such as natural gas and naphtha, alcohols such as methanol, or the like with a reformer including a reforming catalyst inside. The above-described fuel cell system has a higher voltage output and produces energy at a higher efficiency than a direct methanol fuel cell and can be expected to improve in performance.

Various other materials are being examined to be used as the fuel for the fuel cell system provided with the reformer in addition to alcohols such as methanol. Particularly, dimethyl ether is less toxic than methanol and easy to store and carry since dimethyl ether is liquefied at room temperature. Therefore, catalysts for reforming dimethyl ether are being actively developed.

### SUMMARY OF THE INVENTION

An aspect of the present invention inheres in a fuel cell system encompassing a fuel section storing fuel; a vaporizer vaporizing the fuel; a reformer reforming the fuel into reformed gas containing hydrogen; a CO remover configured to reduce or remove carbon monoxide from reformed gas; a fuel cell body having an anode configured to introduce the reformed gas from the CO remover and emit exhaust gas containing hydrogen and a cathode configured to introduce oxygen to react with hydrogen; and a circulation path configured to circulate exhaust gas configured to circulate the exhaust gas to the reformer.

Another aspect of the present invention inheres in a fuel cell system encompassing a fuel section storing fuel; a vaporizer vaporizing the fuel; a reformer reforming the fuel into reformed gas containing hydrogen; a hydrogen separator configured to separate hydrogen selectively from part of the reformed gas; a circulation path configured to circulate separated hydrogen to the reformer; a CO remover configured to reduce or remove carbon monoxide from the reformed gas; and a fuel cell body configured to generate electricity by reacting hydrogen in the reformed gas with oxygen.

Still another aspect of the present invention inheres in a fuel cell system encompassing a fuel section storing fuel; a vaporizer vaporizing the fuel; a reformer reforming the fuel into reformed gas containing hydrogen; a CO remover configured to reduce or remove carbon monoxide from the reformed gas; a fuel cell body configured to generate electricity by reacting hydrogen with oxygen; and a circulation path configured to circulate part of the reformed gas emitted from the CO remover.

### BRIEF DESCRIPTION OF DRAWINGS

FIG. 1 is a block diagram showing a fuel cell system according to a first embodiment of the present invention.

FIG. 2 is a block diagram showing the fuel cell system according to a first modification of the first embodiment.

FIG. 3 is a block diagram showing the fuel cell system according to a second modification of the first embodiment.

FIG. 4 is a block diagram showing the fuel cell system according to a third modification of the first embodiment.

FIG. 5 is a block diagram showing the fuel cell system according to a second embodiment of the present invention.

FIG. 6 is a block diagram showing the fuel cell system according to a first modification of the second embodiment.

FIG. 7 is a block diagram showing the fuel cell system according to a second modification of the second embodiment.

FIG. 8 is a block diagram showing the fuel cell system according to a third modification of the second embodiment.

FIG. 9 is a block diagram showing the fuel cell system according to a third embodiment of the present invention.

FIG. 10 is a block diagram showing the fuel cell system according to a first modification of the third embodiment.

FIG. 11 is a block diagram showing the fuel cell system according to a second modification of the third embodiment.

FIG. 12 is a block diagram showing the fuel cell system according to a third modification of the third embodiment.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and description of the same or similar parts and elements will be omitted or simplified. However, it will be obvious to those skilled in the art that the present invention may be practiced without such specific details.

(First Embodiment)

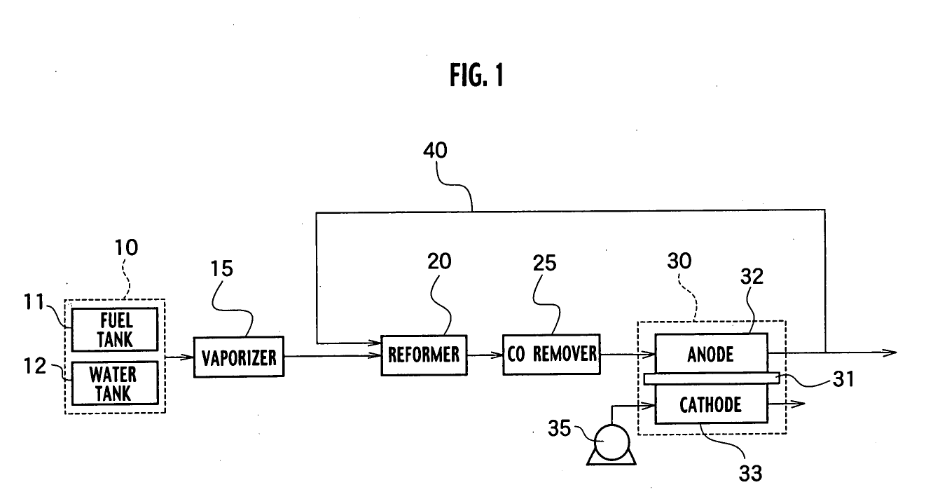

As shown in FIG. 1, a fuel cell system according to a first embodiment of the present invention includes a fuel section 10 storing fuel, a vaporizer 15 vaporizing the fuel, a reformer 20 reforming the fuel into reformed gas containing hydrogen, a CO remover 25 configured to remove or remove carbon monoxide from the reformed gas, a fuel cell body 30 having an anode (fuel electrode) 32 configured to introduce the reformed gas from the CO remover 25 and emit exhaust gas containing hydrogen and a cathode (oxidant electrode) 33 configured to introduce oxygen to react with hydrogen, and a circulation path 40 configured to circulate an exhaust gas containing hydrogen emitted from the anode 32 to the reformer 20.

The fuel section 10 includes a fuel tank 11 which stores fuel to generate hydrogen and a water tank 12 which stores water. As for the fuel, light hydrocarbons such as natural gas, propane, and naphtha, alcohols such as ethanol, ethers such as dimethyl ether, and the like are used. The fuel and water may be simultaneously stored in the same tank. In the first embodiment of the present invention, dimethyl ether or a mixture containing dimethyl ether is suitable for the fuel.

Dimethyl ether has a lower reforming temperature, which is the temperature necessary for a reforming reaction, than another type of hydrocarbon with two or more carbon atoms. Accordingly, when dimethyl ether is used as the fuel, the system is easily processed for insulation and easily miniaturized compared to using hydrocarbon with two or more carbon atoms other than dimethyl ether. Moreover, when using the mixture containing dimethyl ether, the reforming temperature of the mixture can be lowered because the mixture contains dimethyl ether. The suitable content of dimethyl ether is, not less than 50 mol %, and more suitably, not less than 75 mol %.

The downstream side of the fuel section 10 is connected to the vaporizer 15. The vaporizer 15 heats and vaporizes fuel and water supplied from the fuel tank 11 and the water tank 12 respectively. The vaporizer 15 is heated by an external heat source or the like so that the temperature within the vaporizer 15 reaches about 100° C. to 150° C.

The downstream side of the vaporizer 15 is connected to the reformer 20. The reformer 20 reforms the vaporized fuel to produce reformed gas containing hydrogen. Here, the “reformed gas” is a gas containing hydrogen about 50 to 75 mol %. Inside the reformer 20, a reforming catalyst is arranged. In this instance, the reforming catalyst may be filled in the reformer 20. Alternatively, the reforming catalyst may be supported on an inner wall of a channel which flows through the fuel arranged in the reformer 20. The type of reforming catalyst arranged in the reformer 20 is not particularly limited.

When using a light hydrocarbon such as natural gas or naphtha as the fuel, for example, a nickel catalyst such as NiO—Al₂O₃ can be used as the reforming catalyst. A nickel catalyst containing alkali metal such as NiO—K₂O—Al₂O and NiO—CaO—Al₂O₃ can be used as the reforming catalyst, and a ruthenium catalyst such as Ru—Al₂O₃ is also suitable for the reforming catalyst.

When the fuel is methanol, it may be possible to use a copper-zinc catalyst such as CuO—ZnO—Al₂O₃ and Cu—Zn—Al₂O₃. When the fuel is dimethyl ether, it may be possible to use a noble metal-solid acid catalyst such as Pt—Al₂O₃, Pd—Al₂O₃, Rh—Al₂O₃, Pt-zeolite, Pd-zeolite, and Rh-zeolite or a copper-noble metal-solid acid catalyst such as Cu—Rh—Al₂O₃ and Cu—Rh-zeolite. Moreover, a mixture of two or more of the aforementioned catalysts may be used as the reforming catalyst.

When using the above described noble metal-solid acid catalyst or the copper-solid acid catalyst as the reforming catalyst, the weight ratio (supporting ratio) of noble metal or copper to the entire catalyst is suitably 0.25 to 1 wt %, and more suitably, 0.25 to 0.5 wt %. In the copper-noble-solid acid catalyst, the total of the supporting ratios of copper and noble metal is suitably 0.25 to 1 wt %, and more suitably, 0.25 to 0.5 wt %. Al₂O₃ used for the solid acid catalyst is suitably γ—Al₂O₃.

The downstream side of the reformer 20 is connected to the CO remover 25. The CO remover 25 removes carbon monoxide (CO) from the reformed gas. The water-gas shift reaction of CO expressed by the following formula (1); the selective oxidation reaction of CO expressed by the formula (2); and the selective methanation reaction of CO expressed by the formula (3) are applicable to a CO removing reaction taking place in the reformer 20.
CO+H₂O⇄CO₂+H₂ (1)
CO+½O₂→CO₂ (2)
CO+3H₂→CH₄+H₂O (3)
Some of the reactions expressed by the formulae (1) to (3) may be combined.

In the CO remover 25, a CO removal catalyst is arranged. When the water-gas shift reaction expressed by the formula (1) has occurred, it is possible to use a copper-zinc catalyst such as CuO—ZnO and Cu—ZnO and a noble metal catalyst such as Pt—Al₂O₃, Pd—Al₂O₃, and Ru—Al₂O₃ as the CO removal catalyst. When the selective oxidation reaction expressed by the formula (2) has occurred, a ruthenium catalyst such as Ru-zeolite, Ru—Pt-zeolite, a Cu—Mn catalyst such as CuO—MnO and an Fn—Mn catalyst such as Fe₂O₃—MnO can be used. When the selective methanation reaction of CO expressed by the formula (3) has occurred, a noble catalyst such as Ru—Al₂O₃, Ru-zeolite, Ru—Pt-zeolite can be used.

The downstream side of the CO remover 25 is connected to the anode 32 of the fuel cell body 30. The upstream side of the cathode 33 is connected to a compression pump 35. For the fuel cell body 30, a cell stack that includes a plurality of electricity generating sections stacked upon each other can be used. Each of the electricity generating sections is formed by sandwiching a proton-conductive electrolyte membrane 31 between the fuel cell 32 and the cathode 33. Suitably, the proton-conductive electrolyte membrane 31 is made of fluorocarbon polymer including a cation-exchange group such as a sulfonic acid group or a carbonic acid group. Specifically, Nafion (made by Du Pont Ltd., trade name) or the like can be used. Each of the anode 32 and the cathode 33 includes a conductive porous body and a catalyst layer formed thereon.

For the porous body, it is possible to use, for example, a porous sheet which includes platinum-supported carbon black powder held by a binder of water repellent resin such as polytetrafluoroethylene (PTFE). The porous sheet may contain perfluorocarbon sulfonic acid polymer or fine particles covered with the perfluorocarbon sulfonic acid.

Hydrogen in the reformed gas supplied to the anode 32 reacts in the anode 32 as follows:
H₂→2H⁺+2e⁻ (4)
Hydrogen is thus separated into hydrogen ions (protons) and electrons. On the other hand, oxygen in the air supplied to the cathode 33 reacts with the hydrogen ions and electrons in the cathode 33 as follows:
½O₂+2H⁺+2e⁻→+H₂O (5)
Thus, water is produced, and electricity is generated.

Along with operation of the fuel cell body 30, surplus gas in the reaction expressed by formula (4) is emitted from the downstream side of the anode 32 as exhaust gas. This exhaust gas contains unreacted hydrogen. Similarly, surplus gas in the reaction expressed by formula (5) is emitted from the downstream side of the cathode 33 as exhaust gas. This exhaust gas contains unreacted oxygen.

A conduit connected to the downstream side of the anode 32 is connected to the circulation path 40 and connected to the upstream side of the reformer 20. The circulation path 40 circulates part of the exhaust gas emitted from the anode 32, which contains hydrogen, to the reformer 20. In the fuel cell system shown in FIG. 1, the reformed gas fed from the reformer 20, which contains hydrogen, is introduced into the anode 32 via the CO remover 25. In the anode 32, the reaction of formula (4) proceeds. Unreacted hydrogen which has not been used in the reaction of formula (4) is fed to the reformer 20 via the circulation path 40.

The residual exhaust gas which is not fed to the circulation path 40 is supplied to a combustor (not shown) arranged adjacent to the reformer 20 for catalyst combustion. Heat generated in the combustor can be utilized for heating the reformer 20.

In the fuel cell system according to the first embodiment, part of the exhaust gas emitted from the anode 32, which contains hydrogen, is circulated to the reformer 20 through the circulation path 40. In the case of using dimethyl ether as the fuel stored in the fuel tank 11, reactions expressed by formulae (6) and (7) proceed.
CH₃OCH₃+H₂O—2CH₃OH (6)
CH₃OH+H₂O→CO₂+3H₂ (7)
Herein, when hydrogen is fed to the reformer 20 from the circulation path 40, hydrogen atoms (H) generated by a dissociation reaction on the surface of the catalyst acts with ether linkages of dimethyl ether, so that the ether linkages (C—O—C) are easily broken. Accordingly, a decomposition reaction of dimethyl ether, which is expressed by formula (6), is promoted. Furthermore, the promotion of the decomposition reaction of formula (6) causes the reforming reaction of methanol, which is shown in formula (7), to easily progress, thus increasing the hydrogen reforming efficiency. Therefore, with the fuel cell system according to the first embodiment, the decomposition and reforming reactions in the reformer 20 are promoted by supplying hydrogen to the reformer 20, thus increasing the reforming efficiency (conversion) of the fuel (dimethyl ether).

Moreover, the surplus hydrogen emitted from the anode 32 is utilized as hydrogen to be fed to the reformer 20. Therefore, there is no need to install new equipment for supplying hydrogen to the reformer 20, so the fuel cell system shown in FIG. 1 can be miniaturized.

(First Modification of the First Embodiment)

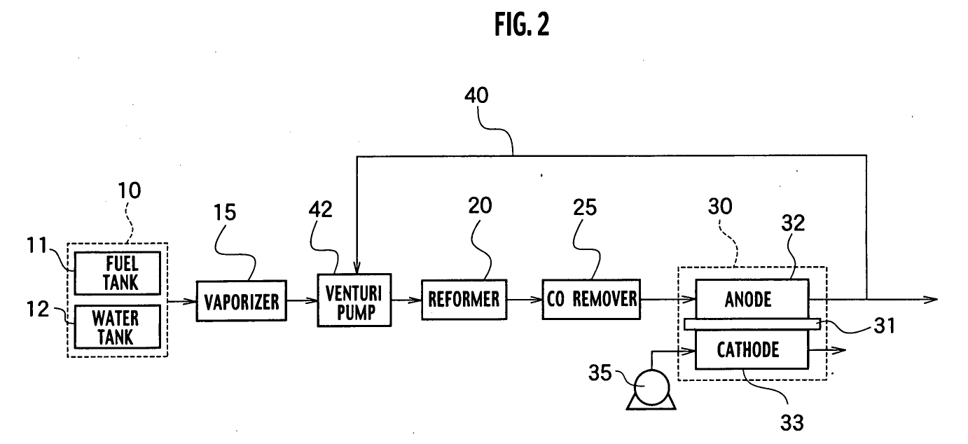

As shown in FIG. 2, a fuel cell system according to a first modification of the first embodiment includes a venturi pump 42 connected to the upstream side of the reformer 20.

In the venturi pump 42, gas mixture directed from the vaporizer 15 to the reformer 20 flows through a constriction formed inside the venturi pump 42 to create negative pressure on the side of the circulation path 40. The gas within the circulation path 40 is sucked into the venturi pump 42 by the negative pressure and fed to the reformer 20 together with the gas mixture from the vaporizer 15. The circulation path 40 connected to the upstream side of the venturi pump 42 is provided with a one-way valve (not shown) to prevent backflow.

In the fuel cell system according to the first modification of the first embodiment, the reformed gas produced in the reformer 20, which contains hydrogen, is fed to the anode 32 via the CO remover 25. The exhaust gas emitted from the anode 32 contains unreacted hydrogen. Therefore, the efficiency of reforming the fuel can be increased by circulating hydrogen in the exhaust gas to the reformer 20, by negative pressure occurring in the venturi pump 42. The use of negative pressure in the venturi pump 42 allows the circulated gas to be sucked without installing any pump, thus the fuel cell system can be miniaturized.

(Second Modification of the First Embodiment)

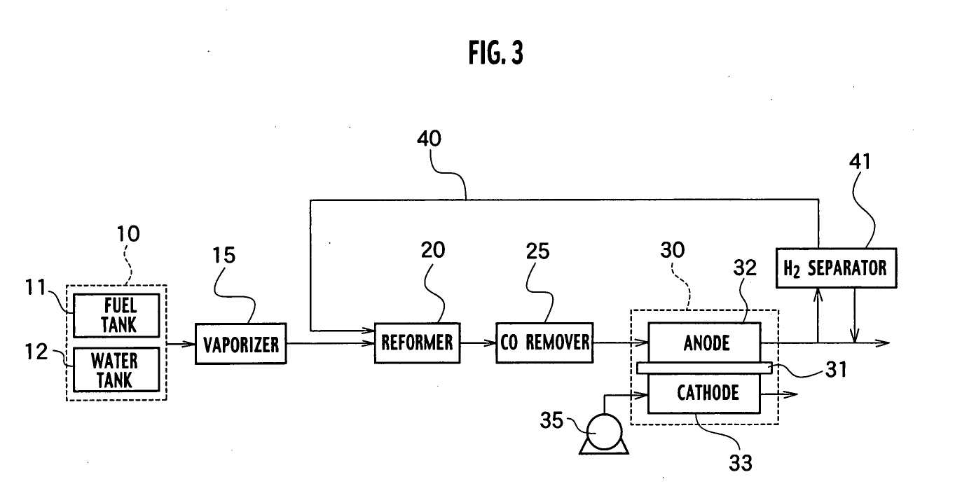

As shown in FIG. 3, a fuel cell system according to a second modification of the first embodiment includes a hydrogen separator 41 configured to separate hydrogen selectively from the exhaust gas emitted from the anode 32 and supply the separated hydrogen to the reformer 20 via the circulation path 40.

The upstream side of the hydrogen separator 41 is connected to the anode 32, and the downstream side thereof is connected to the circulation path 40. Inside the hydrogen separator 41, a hydrogen separation membrane is arranged. The hydrogen separation membrane selectively transmits hydrogen. Examples that are suitable for the hydrogen separation membrane are a separation membrane using hydrogen storage alloy, a separation membrane using polymer, a separation membrane using inorganic material, and the like. As for the separation membrane using hydrogen storage alloy, a separation membrane using a thin film of palladium, palladium alloy, or the like is suitable. As for the separation membrane using polymer, a separation membrane using polyimide, polyamide, or the like is suitable. Examples of the separation membrane using inorganic material are a silica film, a zeolite film, a zirconium film, and the like.

In the fuel cell system according to the second modification of the first embodiment, part of the exhaust gas emitted from the anode 32, which contains unreacted hydrogen, is fed to the hydrogen separator 41. The exhaust gas fed to the hydrogen separator 41 becomes gas containing almost only hydrogen by the hydrogen separation membrane. Hydrogen is thus supplied to the reformer 20, so that the reforming reaction can be promoted. Accordingly, the reforming efficiency of the fuel into hydrogen can be increased. Hydrogen to be supplied to the reformer 20 is circulated by the circulation path 40. Therefore, there is no need to install a tank or the like to supply hydrogen, thus, the fuel cell system can be miniaturized.

(Third Modification of the First Embodiment)

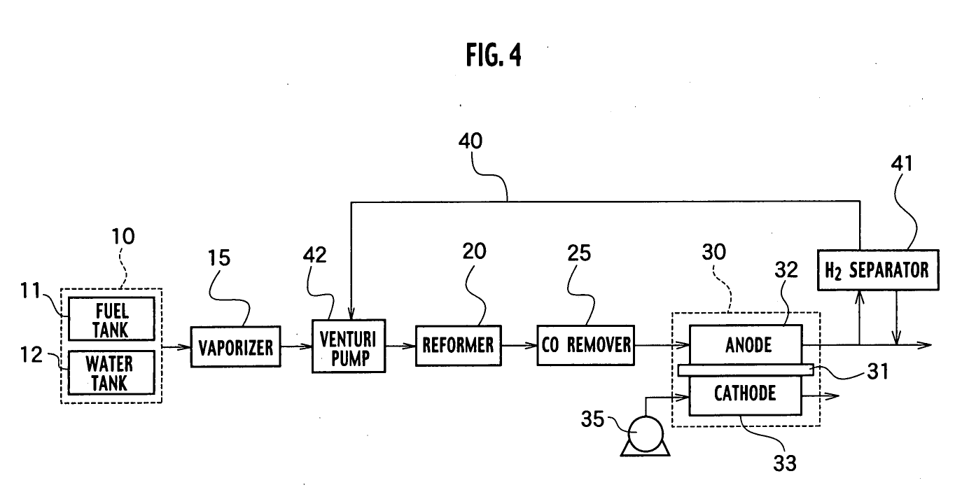

As shown in FIG. 4, a fuel cell system according to a third modification of the first embodiment includes a hydrogen separator 41 connected to the downstream side of the anode 32 and a venturi pump 42 connected to the upstream side of the reformer 20. The configurations of the hydrogen separator 41 and the venturi pump 42 are the same as those of the fuel cell system shown in FIGS. 2 and 3, and a detailed description thereof is omitted.

In the fuel cell system as shown in FIG. 4, hydrogen is taken out by the hydrogen separation membrane in the hydrogen separator 41 from part of the exhaust gas emitted from the anode 32, which contains unreacted hydrogen. The gas containing hydrogen is actively fed to the reformer 20 by negative pressure created by the venturi effect of the venturi pump 42. Therefore, the fuel cell system can be miniaturized, and the reforming efficiency can be increased.

(Second Embodiment)

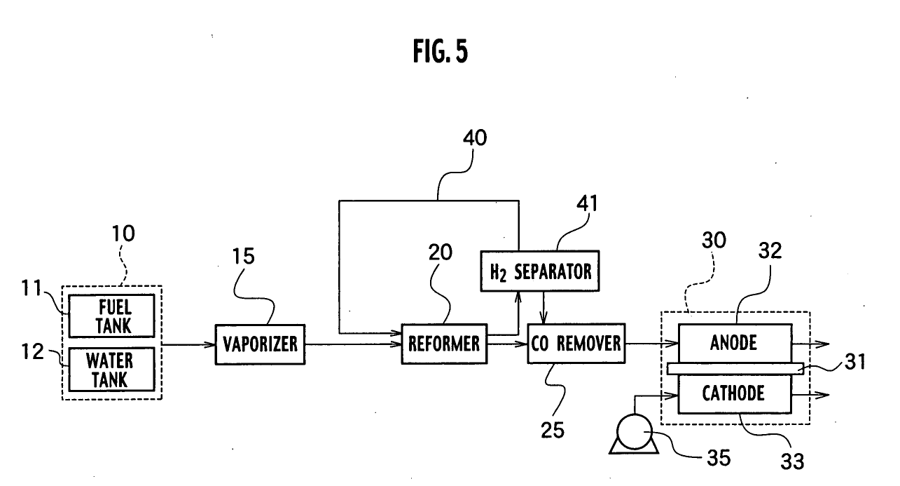

As shown in FIG. 5, a fuel cell system according to a second embodiment of the present invention includes fuel section 10 storing the fuel, a vaporizer 15 vaporizing the fuel, a reformer 20 reforming the fuel into reformed gas containing hydrogen, a hydrogen separator 41 configured to separate hydrogen selectively from part of the reformed gas, a circulation path 40 configured to circulate separated hydrogen to the reformer 20, a CO remover 25 configured to reduce or remove carbon monoxide from the reformed gas, and a fuel cell body 30 configured to generate electricity by reacting hydrogen with oxygen.

The downstream side of the reformer 20 is connected to the hydrogen separator 41 and the CO remover 25 respectively. The downstream side of the hydrogen separator 41 is connected to the circulation path 40 and the CO remover 25 respectively. The downstream side of the CO remover 25 is connected to the anode 32. Part of the reformed gas reformed in the reformer 20 and contains hydrogen is introduced to the hydrogen separator 41, and hydrogen is selectively separated therefrom by the hydrogen separation membrane. The separated hydrogen is circulated to the upstream side of the reformer 20 through the circulation path 40. Part of the reformed gas remaining in the hydrogen separator 41 is introduced to the CO remover 25, and CO is reduced. The other part of the reformed gas which is not fed to the hydrogen separator 41 from the reformer 20 is also introduced to the CO remover 25, and CO is reduced. The CO remover 25 reduces or removes CO from the reformed gas so that the molar concentration of CO reaches 10 ppm or less. The reformed gas from which CO was removed is supplied to the anode 32 of the fuel cell body 30 to generate electricity.

In the fuel cell system according to the second embodiment, hydrogen in the reformed gas which is produced in the reformer 20 and selectively separated in the hydrogen separator 41 is circulated again to the reformer 20 via the circulation path 40. The reforming reaction performed in the reformer 20 can be speed up by the presence of hydrogen, thus increasing the efficiency of reforming the fuel.

(First Modification of the Second Embodiment)

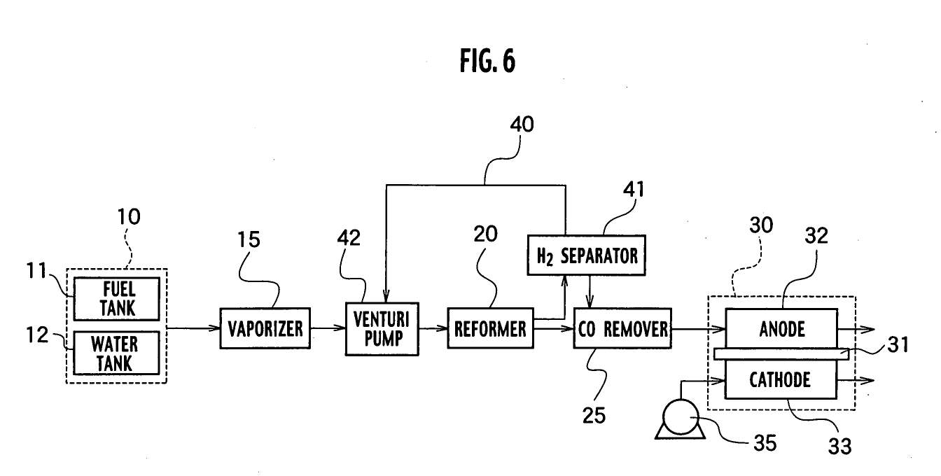

As shown in FIG. 6, a fuel cell system according to a first modification of the second embodiment includes the venturi pump 42 connected to the upstream side of the reformer 20.

In the fuel cell system according to the first modification of the second embodiment, hydrogen is separated by the hydrogen separator 41 from part of the reformed gas produced in the reformer 20. The separated hydrogen is fed to the circulation path 40 and actively circulated to the reformer 20 by use of negative pressure created by the venturi pump 42, thus eliminating the need for a pump to feed hydrogen. Accordingly, the fuel cell system can be miniaturized.

(Second Modification of the Second Embodiment)

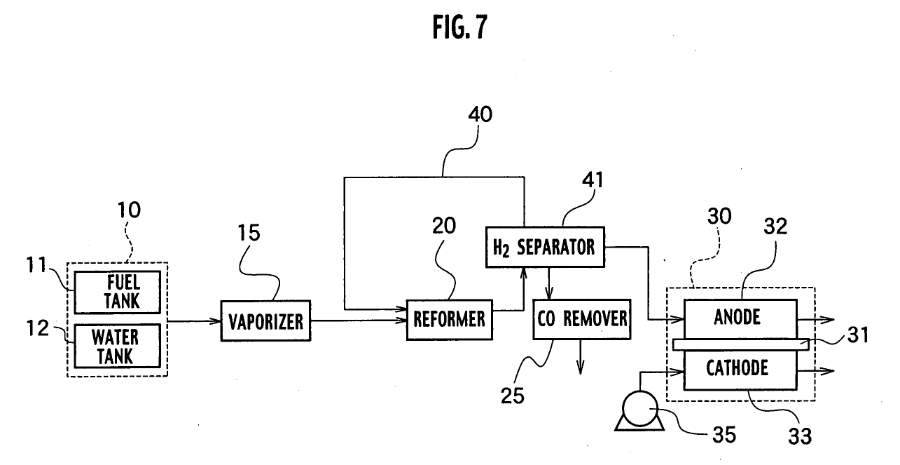

As shown in FIG. 7, in a fuel cell system according to a second modification of the second embodiment, the downstream side of the reformer 20 is connected to the hydrogen separator 41. The downstream side of the hydrogen separator 41 is connected to the circulation path 40, the CO remover 25, and the anode 32.

All the gas reformed in the reformer 20 is introduced to the hydrogen separator 41 via a conduit. The hydrogen separator 41 selectively separates hydrogen with the hydrogen separation membrane arranged inside. The separated hydrogen is fed to the anode 32. In the anode 32, the reactions expressed by the formulae (4) and (5) progress to generate electricity. Part of the hydrogen separated in the hydrogen separator 41 is circulated to the reformer 20 through the circulation path 40. On the other hand, the reformed gas remaining in the hydrogen separator 41 has CO removed in the CO remover 25 and is then emitted to the outside.

In the fuel cell system according to the second modification of the second embodiment, all the reformed gas produced in the reformer 20, which contains hydrogen, is once supplied to the hydrogen separator 41 and separated into hydrogen and other components of the reformed gas in the hydrogen separator 41. The obtained hydrogen is used for generating electricity in the fuel cell body 30 while being fed to the reformer 20 via the circulation path 40. The reforming efficiency of the reformer 20 can be increased by supplying hydrogen to the reformer 20, so that more hydrogen can be obtained. The obtained hydrogen is further separated in the hydrogen separator 41 and supplied to the anode 32. Accordingly, it is possible to obtain a fuel cell system with higher reforming efficiency.

(Third Modification of the Second Embodiment)

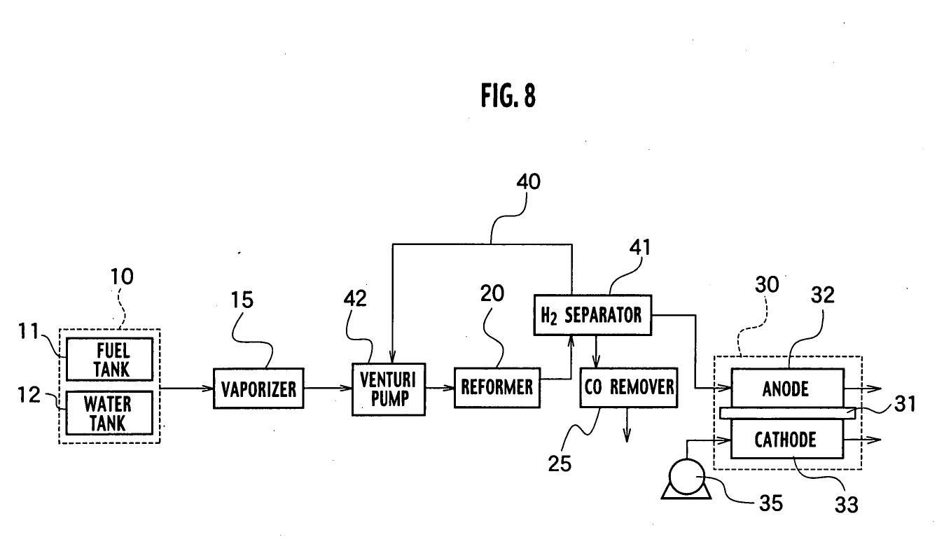

A fuel cell system according to a third modification of the second embodiment includes the venturi pump 42 connected to the upstream side of the reforming unit 20 as shown in FIG. 8.

In the fuel cell system according to the third modification of the second embodiment, hydrogen separated by the hydrogen separator 41 is fed to the circulation path 40 and actively circulated to the reformer 20 by use of negative pressure created by the venturi pump 42. Thus, a pump needed to feed hydrogen is omitted so the size of the fuel cell system can be miniaturized.

(Third Embodiment)

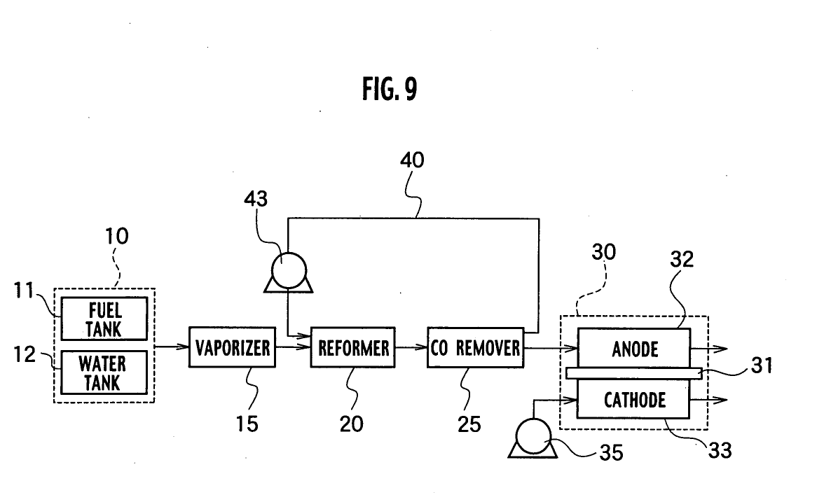

As shown in FIG. 9, a fuel cell system according to a third embodiment of the present invention includes a fuel section 10 storing fuel, a vaporizer 15 vaporizing the fuel, a reformer 20 reforming the fuel into reformed gas containing hydrogen, a CO remover 25 configured to reduce or remove carbon monoxide from the reformed gas, a fuel cell body 30 configured to generate electricity by reacting hydrogen with oxygen, and a circulation path 40 configured to circulate part of the reformed gas emitted from the CO remover 25.

The upstream side of the circulation path 40 is connected to the CO remover 25, and the downstream side thereof is connected to the reformer 20. The circulation path 40 may have a pump 43 which supplies reformed gas to the circulation path 40. The type of pump is not particularly limited. The other configurations are substantially the same as those of the fuel cell system shown in the first and second embodiments, thus, detailed description thereof is omitted.

In the fuel cell system according to the third embodiment, reformed gas reformed CO in the CO remover 25 is provided to the reformer 20 via the circulation path 40 and the pump 43. Since, hydrogen can be supplied to the reformer 20, efficiency for generating hydrogen from the fuel is increased and the reforming efficiency for the fuel cell system is also increased.

(First Modification of the Third Embodiment)

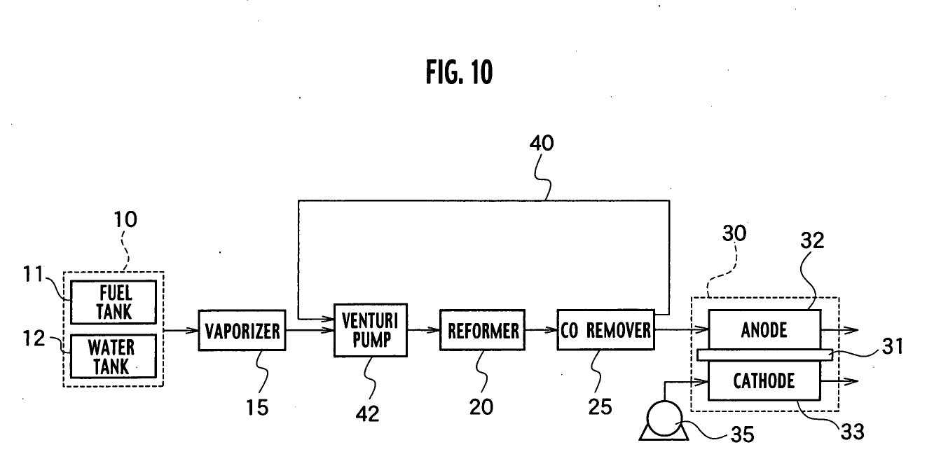

As shown in FIG. 10, a fuel cell system according to a first modification of the third embodiment includes the venturi pump 42 connected to the upstream side of the reforming unit 20.

In the fuel cell system according to the first modification of the third embodiment, since the upstream side of the venturi pump 42 is pressured by a constriction formed in the venturi pump 42, the reformed gas containing hydrogen is actively supplied to the reformer 20. Thus, a pump to feed hydrogen is omitted so the size of the fuel cell system can be miniaturized.

(Second Modification of the Third Embodiment)

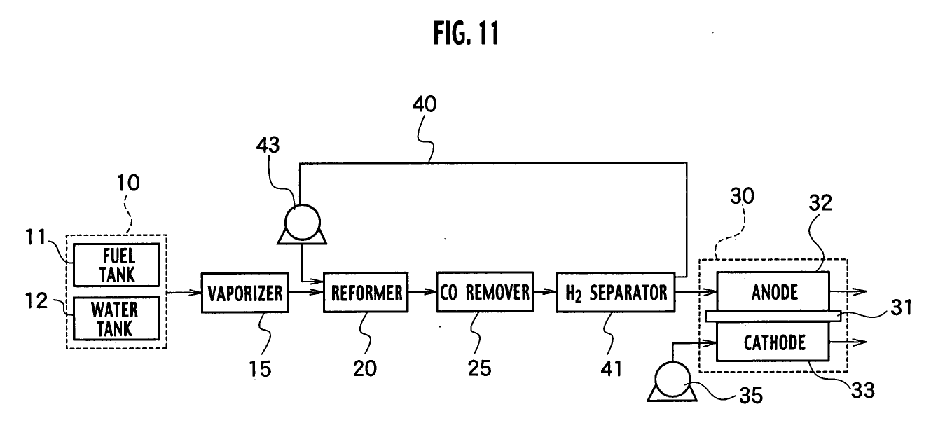

As shown in FIG. 11, a fuel cell system according to a second modification of the third embodiment includes the hydrogen separator 41 configured to separate hydrogen from the exhaust gas emitted from the CO remover 25 and circulate separated hydrogen to the reformer via the circulation path 40. The upstream side of the hydrogen separator 41 is connected to the CO remover 25 and the downstream side thereof is connected to the circulation path 40 and the anode 32.

In the fuel cell system according to the second modification of the third embodiment, reformed gas emitted from the CO remover 25 containing hydrogen is introduced to the hydrogen separator 41 and fed to the upstream side of the reformer 20 via the circulation path and the pump 43. Thus, reforming reaction occurring in the reformer 20 is prompted and efficiency for generating hydrogen from the fuel is increased. Since hydrogen is fed from the circulation path 40, the pump to supply hydrogen is omitted and the size of the fuel cell system is also miniaturized.

(Third Modification of the Third Embodiment)

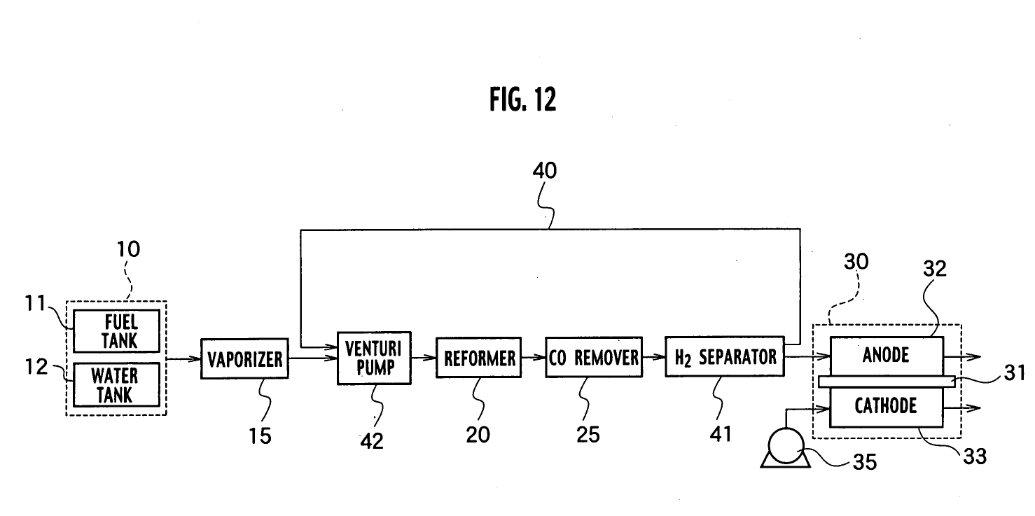

As shown in FIG. 12, a fuel cell system according to a third modification of the third embodiment includes the hydrogen separator 41 arranged between the CO remover 25 and the anode 32 and the venturi pump 42 connected to the upstream side of the reformer 20.

In the fuel cell system according to the third modification of the third embodiment, hydrogen is separated from the reformed gas emitted from the CO remover 25 by the hydrogen separation membrane arranged in the hydrogen separator 41. Gas containing hydrogen is actively supplied to the negative pressure caused by the venturi effect provided by the venturi pump 42. Therefore, the size of the fuel cell system is miniaturized and efficiency for reforming fuel into hydrogen is also increased.

### FIRST EXAMPLE

A first example of the fuel cell system shown in FIG. 4 was prepared. Liquid dimethyl ether was used as the fuel. As the catalyst for reforming dimethyl ether, Pt—γAl₂O₃ (Pt: 1 wt %) was arranged on the inner wall of a channel arranged in the reformer 20. The channel passes through fuel from the fuel section 10. For the CO remover 25, a channel including two sections having a shift section and a selective methanation section was prepared. A shift catalyst (Pt—Al₂O₃) removing carbon monoxide in the gas (CO removal catalyst) was arranged on the inner wall of the channel of the shift section. A selective methanation catalyst (Ru-zeolite) prompting selective methanation reaction was arranged on the inner wall of the channel of the selective methanation section. A hydrogen separation membrane composed of a Pd thin film with a thickness of 5 μm was arranged in the hydrogen separator 41.

First, gas mixture of dimethyl ether and water vapor (molar ratio: ¼) was introduced as the fuel to the reformer 20 to generate reformed gas using a mass flow controller. Next, reformed gas obtained in the reformer 20 was introduced to the CO remover 25, and CO in the reformed gas was reduced so that the molar concentration thereof was reduced to less than 10 ppm. The obtained reformed gas was supplied to the anode 32 of the fuel cell body 30 connected thereto via a conduit. Air was supplied to the cathode 33 of the fuel cell body 30 by use of the compression pump 35. Hydrogen was supplied to the anode 32 at 100 cc/min.

During operation of the fuel cell body 30, part of the exhaust gas emitted from the anode 32, which contained hydrogen, was introduced to the circulation path 40 by use of the venturi pump 42. The exhaust gas introduced to the gas circulation path 40 was separated into hydrogen and other components in the hydrogen separator 41 were composed of the hydrogen separation membrane of a Pd thin film. Substantially only hydrogen was circulated to the reformer 20.

The fuel cell system shown in FIG. 4 was then connected to an electronic load. Checking the electricity generation characteristic, an output of about 10 W was obtained, and at this time, the volume of the reformer 20 was 50 cc.

### SECOND EXAMPLE

A second example of the fuel cell system shown in FIG. 4 was prepared. Liquid dimethyl ether was used as the fuel. Pd—γAl₂O₃ (Pd: 1 wt %) was arranged in the inner wall of the channel arranged in the reformer 20, and used as the catalyst for reforming dimethyl ether. In the CO remover 25, the shift section containing the shift catalyst (Pt—Al₂O₃) and the selective methanation section containing the selective methanation catalyst (Ru-zeolite) are arranged so as to promote two steps of reforming reactions. A hydrogen separation membrane composed of a Pd thin film with a thickness of 5 μm was used as the hydrogen separator 41.

First, a gas mixture of dimethyl ether and water vapor (molar ratio: ¼) was introduced as the fuel to the reformer 20 by use of a mass flow controller. Next, the reformed gas obtained by reformation was introduced to the CO remover 25, and CO in the reformed gas was reduced so that the molar concentration thereof was reduced 10 ppm or less. The obtained reformed gas was supplied to the anode 32. Air was supplied to the cathode 33 by use of the compression pump 35 to operate the fuel cell. Hydrogen was supplied to the anode 32 at 100 cc/min.

During operation of the fuel cell, part of the exhaust gas emitted from the anode 32, which contained hydrogen, was introduced to the circulation path 40 by use of the venturi pump 42. The exhaust gas introduced to the gas circulation path 40 was separated into hydrogen and other components in the hydrogen separator 41 were composed of the hydrogen separation membrane of a Pd thin film. Only hydrogen was then circulated to the reformer 20.

The obtained fuel cell system was then connected to an electronic load. Checking the electricity generation characteristic, the obtained output was about 10 W, and at this time, the volume of the reformer 20 was 50 cc.

### FIRST COMPARATIVE EXAMPLE

A fuel cell system according to the first comparative example was produced, which did not circulate part of the hydrogen produced by reformation to the reformer (which did not include the circulation path 40). The other operational conditions were the same as those of the first and second examples. In the fuel cell system according to the first comparative example, the reformer required a volume of 150 cc to obtain an output of 10 W, which was the same as the outputs of the first and second examples.

The aforementioned examples revealed that, in the first and second examples, in which part of the exhaust gas emitted from the anode 32, which contained hydrogen, was circulated to the reformer 20, the reformer 20 could be made smaller in volume than that of the first comparative example. This difference arises from the conversion efficiency of the reforming reaction increased by circulating part of the hydrogen produced by reformation to the reformer 20. It was also found that the reformer 20 could be made smaller in volume by rearranging the circulation path 40 in any of the cases using the fuel cell systems 2 and 3 as shown in FIGS. 1 to 3 and FIGS. 5 to 11.

### SECOND COMPARATIVE EXAMPLE

A fuel cell system according to the second comparative example was prepared, which supplied hydrogen to the reformer 20 by use of a hydrogen tank instead of circulating hydrogen produced by reformation to the reformer 20. Hydrogen was supplied via a hydrogen supply line arranged between the hydrogen tank and the reformer 20. The fuel cell system was then operated, and an output of 10W was obtained. At this time, the volume of the reformer 20 was 50 cc, the same as the first and second examples. However, the installation of the hydrogen tank and the hydrogen supply line increased the size of the fuel cell system.

It could be inferred from the above result that the fuel cell systems according to the first and second embodiments could be miniaturized because there is no need for the hydrogen tank and the hydrogen supply line. Accordingly, the fuel cell systems according to the first and second embodiments may be useful for power supplies for electronic devices such as notebook PCs and VTRs in addition to portable power supplies.

Various modifications will become possible for those skilled in the art after receiving the teachings of the present disclosure without departing from the scope thereof.

1. A fuel cell system comprising
a fuel section storing fuel;
a vaporizer vaporizing the fuel;
a reformer reforming the fuel into reformed gas containing hydrogen;
a CO remover configured to reduce or remove carbon monoxide from reformed gas;
a fuel cell body having an anode configured to introduce the reformed gas from the CO remover and emit exhaust gas containing hydrogen and a cathode configured to introduce oxygen to react with hydrogen; and
a circulation path configured to circulate exhaust gas configured to circulate the exhaust gas to the reformer.

2. The fuel cell system of claim 1, further comprising a venturi pump connected to the upstream side of the reformer configured to create negative pressure to the downstream side of the circulation path to suck the exhaust gas provided from the circulation path.

3. The fuel cell system of claim 1, further comprising a hydrogen separator connected to the upstream side of the circulation path configured to separate hydrogen from the exhausted gas.

4. The fuel cell system of claim 3, wherein a separation membrane is arranged in the hydrogen separator.

5. The fuel cell system of claim 1, wherein the fuel includes dimethyl ether.

6. The fuel cell system of claim 1, wherein the fuel includes a mixture of dimethyl ether and one of methanol and ethanol.

7. The fuel cell system of claim 1, further comprising a selective methanation catalyst and a carbon monoxide removal catalyst arranged in the CO remover.

8. A fuel cell system comprising:
a fuel section storing fuel;
a vaporizer vaporizing the fuel;
a reformer reforming the fuel into reformed gas containing hydrogen;
a hydrogen separator configured to separate hydrogen selectively from part of the reformed gas;
a circulation path configured to circulate separated hydrogen to the reformer;
a CO remover configured to reduce or remove carbon monoxide from the reformed gas; and
a fuel cell body configured to generate electricity by reacting hydrogen in the reformed gas with oxygen.

9. The fuel cell system of claim 8, wherein the CO remover is connected to the downstream side of the reformer and the hydrogen separator and supplies hydrogen in the reformed gas to the fuel cell body.

10. The fuel cell system of claim 8, wherein the hydrogen separator is connected to the downstream side of the reformer and the upstream side of the CO remover and supplies hydrogen separated from the reformed gas to the fuel cell body.

11. The fuel cell system of claim 8, further comprising a venturi pump connected to the upstream side of the reformer configured to create negative pressure to the downstream side of the circulation path to suck the exhaust gas provided from the circulation path.

12. The fuel cell system of claim 8, wherein a separation membrane is arranged in the hydrogen separator.

13. The fuel cell system of claim 8, wherein the fuel includes dimethyl ether.

14. The fuel cell system of claim 8, wherein the fuel includes a mixture containing dimethyl ether and one of methanol and ethanol.

15. The fuel cell system of claim 8, further comprising a selective methanation catalyst and a carbon monoxide removal catalyst arranged in the CO remover.

16. A fuel cell system comprising:
a fuel section storing fuel;
a vaporizer vaporizing the fuel;
a reformer reforming the fuel into reformed gas containing hydrogen;
a CO remover configured to reduce or remove carbon monoxide from the reformed gas;
a fuel cell body configured to generate electricity by reacting hydrogen with oxygen; and
a circulation path configured to circulate part of the reformed gas emitted from the CO remover.

17. The fuel cell system of claim 16, further comprising a venturi pump connected to the upstream side of the reformer configured to create negative pressure to the downstream side of the circulation path to suck the exhaust gas provided from the circulation path.

18. The fuel cell system of claim 16, further comprising a hydrogen separator connected to the upstream side of the circulation path configured to separate hydrogen from the exhausted gas.

19. The fuel cell system of claim 18, wherein a separation membrane is arranged in the hydrogen separator.

20. The fuel cell system of claim 16, wherein the fuel includes dimethyl ether.

21. The fuel cell system of claim 16, wherein the fuel includes dimethyl ether and one of methanol and ethanol.

22. The fuel cell system of claim 16, further comprising a selective methanation catalyst and a carbon monoxide removal catalyst arranged in the CO remover.
